(19) United States
(12) Patent Application Publication
(10) Pub. No.: US 2010/0154049 A1
(43) Pub. Date: Jun. 17, 2010

(54) TERMINAL, SECURITY SETTING METHOD, AND PROGRAM THEREOF

(75) Inventors: Hideo Yoshimi, Tokyo (JP); Nobuyuki Enomoto, Tokyo (JP); Youichi Hidaka, Tokyo (JP); Atsushi Iwata, Tokyo (JP); Kazuo Takagi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 11/993,772

(22) PCT Filed: Jun. 27, 2006
(86) PCT No.: PCT/JP2006/312801

§ 371 Date: Dec. 21, 2007

(30) Foreign Application Priority Data
Jul. 8, 2005 (JP) 2005-199705

(51) Int. Cl. G06F 21/20; G06F 15/16

(52) U.S. Cl. 726/13; 726/25

(57) ABSTRACT

[Problems to be solved] To provide a system capable of controlling a PC firewall responding to a location, thereby to prevent a third person from intruding into a PC without being restricted by an application.

[Means to solve the problems] A first security system includes: a network recognizing unit for performing a test for confirming whether an IP address allotted to the PC coincides with a specification value, and notifying its test result to a security setting unit; the security setting unit for, upon receipt of the test result from the network recognizing unit, notifying a setting modification command to a firewall unit based upon its test result; and the firewall unit for, upon receipt of the setting modification command from the security setting unit, executing a packet filtering responding to its command.

### APPLICABLE FIELD IN THE INDUSTRY

The present invention relates to a security technology, and more particularly to a technology for ensuring a security of a computer to be connected to a network.

### BACKGROUND ART

With an enhancement in a technology of the network such as Internet, leakage of information that a personal computer (PC) etc. retains due to an unauthorized access to the PC etc. by a malicious third person has become a problem.

Various technologies have been proposed for a purpose of solving such a problem (for example, Patent document 1). The technology of Patent document 1 is a technology of integrally building a firewall into a gateway, and performing a security by judging whether or not to execute a filtering of a transmitted packet based upon an IP address or a port number thereof.

On the other hand, in recent years, with miniaturization of the PC, it has become possible for a user to carry the PC with ease. Enabling the PC to be carried in such a manner gives rise to the situation where the number of the networks to which the PC is connected is not limited to one. For example, with an employee of a company, the case that not only he/she connects the PC supplied by the company to an intranet within the company, but also he/she takes out its PC to his/her home or a business trip destination, and connects it to the network in an outing destination is thinkable, and thus, the PC has come to be connected to various networks.

Allowing the PC to be connected to various networks in such a manner necessitates a security countermeasure responding to the networks to which the PC is connected.

For example, connecting the PC to the company's intranet does not necessitate a special countermeasure in the PC side because the intranet is guarded with a firewall against Internet's attacks, whereby the security level is high.

On the contrary, in a case of connecting the PC to the public networks such as a hotel's network, and a station's network, the third person could intrude into the PC unless any security countermeasure is taken in the PC side because the public networks are not guarded with firewall against Internet's attacks, whereby the security level is low.

Further, in this case, confidential data preserved in the PC also could leak out to the third person. For example, data set sharedly, which is accessible from other terminals as well connected to an identical network, could leak out to the third person unconsciously.

Thus, when the PC comes to be connected to various networks, the security setting and the security level of the PC have to be modified flexibly responding to the networks to which the PC is connected.

However, the technology of the Patent document 1, which does not envisage that the network to which a client server itself makes a connection varies at moments, is a technology of executing the filtering of the packet while making a reference to a filtering policy at any time. Thus, even in a case where taking a security countermeasure is not necessitated, resultantly, the filtering of the packet is executed.

For this reason, as a rule, a user makes a setting manually responding to the networks to which the PC is connected.

For example, in a case of making a connection to the network such as the public network of which the security level is low, a file sharing function is switched off through a standard screen of Operating System (OS) for a purpose of preventing intrusion into the PC. Even though an access is made from the network, making this setting modification enables its access to be filtered.

Further, in a case where someone makes a connection to the intranet once again to exchange information with the other employee, for example, at the time that someone has come back to the company from an outgoing, he/her switches on the file sharing function.

However, manually performing these operations demands a lot of times and burdens. Further, manually performing these operations gives rise to the possibility that information leakage from the PC occurs due to a human mistake. For example, for the above-mentioned reason, making a connection to the network of which the security level is low necessitates switching off the file sharing function; however some users carelessly could make a connection to the risky network with this function switched on. In this case, there is the risk that the third person intrudes into the PC in some cases, and the sharing file leaks out to the third person in some cases.

The technology for solving such a problem is described in Patent document 2. The technology described in Patent document 2 is a technology of, after automatically detecting a current location with a software process, automatically modifying the setting of the application such as a file sharing responding to its location. Specifically, the technology is a technology of, after automatically detecting the current location from an identifier (SSID: Service Set Identification) of an access point of a wireless LAN to which a connection is made, controlling a file sharing function and a downloading function responding to its location by an external apparatus, thereby allowing a security level of the PC to be maintained.

Hereinafter, the points at issue of the prior arts will be described.

The first point at issue is that the control of the security level of the PC by controlling an operation of the application responding to a location cannot prevent the third person from intruding, which is inconvenient in handling.

The reason is described below. The Patent document 1 discloses the method of on/off-controlling the application by the external apparatus as a method of maintaining the security level; however preventing the third person from intruding necessitates controlling all applications installed into the PC. However, it is only a very limited number of the dedicated applications such as the file sharing function and the downloading function that can be on/of-controlled by the external apparatus, and it is difficult to put restriction upon operation of the standard applications other than these due to a difference of the packing method for each application. For example, the external apparatus cannot on/off-control a mailing function, a file transferring function, or the like, whereby, in a case where these applications become an object of an attack by the third person, with the method of the Patent document 1, a risk of the third person intruding into the PC cannot be avoided, which is inconvenient in handling.

Further, whenever a new application is installed into the PC, the setting of the PC has to be modified so that its application can be controlled, which is inconvenient in handling.

The second point at issue is that restriction cannot be put upon data that is spontaneously transmitted toward the network from the PC, whereby confidential information of the PC cannot be prevented from leaking out to the outside, which is inconvenient in handling.

The reason is described below. The Patent document 1 discloses the method of on/off-controlling the file sharing function as a method of maintaining the security level; however it is a point as to whether to execute the filtering of the packet received from the other terminal connected to the network that can be controlled herein, and a point as to whether to execute the filtering of the packet that is spontaneously transmitted toward the network from its own terminal cannot be controlled. For example, confidential information could be transmitted from its own terminal to the other PC due to a human mistake, whereas the method of the Patent document 1 cannot prevent such an information leakage of the PC, which is inconvenient in handling.

The third point at issue is that an attempt to identify the location from the SSID of the access point gives rise to the possibility that the current location is erroneously recognized if the setting is omitted, which is inconvenient in handling.

The reason is described below. The technology of the Patent document 1 necessitates pre-setting the SSID of a safe access point to the PC; however in case where the access point has been set for each floor of the intranet, the access point to which a connection is made varies floor by floor, whereby the SSID differs responding hereto. In such a case, unless the SSIDs of all access points installed in the intranet are pre-set to the PC, resultantly, it is erroneously judged that the PC stays in a risky outdoor network at the time of having shifted to the different floor even if it stays in the intranet, which is inconvenient in handling.

The fourth point at issue is that an attempt to identify the location from the SSID of the access point gives rise to the possibility that the current location is erroneously recognized due to mistaking the access point, which is inconvenient in handling.

The reason is described below. It is not guaranteed that the SSID of the access point is a peculiar value that is unique in the world, whereby the SSID of the access point installed in the intranet could accidentally coincide with that of the access point installed in the outdoors. In this case, it is erroneously judged that the PC stays in a safe intranet even if it stays in a risky outdoor network because the access point cannot be identified, which is inconvenient in handling.

The fifth point at issue is that an attempt to identify the location from the SSID of the access point gives rise to the possibility that the current location is erroneously detected in case a where the access point has failed, which is inconvenient in handing.

The reason is described below. In a case where the failure has occurred in the access point due to some cause, even if an attempt to access its access point is made, the SSID of the access point cannot be acquired; however in this case, the method of the Patent document 1 allows the erroneous judgment that the PC stays in a risky outdoor network to be made even if it stays in the intranet, which is inconvenient in handling.

For the reasons mentioned above, in the conventional technique, not only the location cannot be accurately recognized, but also it is impossible to prevent the PC from being intruded by the third person and the information from leaking out from the PC in a case of being in connecting to the risky network.

[Patent Document 1] JP-P2005-064820A

[Patent Document 2] JP-P2003-316650A

### DISCLOSURE OF THE INVENTION

### Problems to be Solved by the Invention

The task that the present invention is to solve the above-mentioned points at issue, and an object of the present invention is to provide a system capable of controlling a PC firewall in responding to the location, thereby to prevent the third person from intruding into the PC without being restricted by an application.

Further, another object of the present invention is to provide a system capable of executing the filtering of data as well, which is spontaneously transmitted toward the network from the PC, with the firewall, thereby to prevent confidential information of the PC from leaking out to the third person.

Further, another object of the present invention is to provide a system capable of recognizing the location of the PC, which stays in any place of the intranet, with ease while stubbornly excluding a burdensome setting practice to be done by the user.

Further, another object of the present invention is to provide a security system of accurately recognizing the location by combining pieces of information peculiar to the method of recognizing the location.

Further, another object of the present invention is to provide a security system capable of accurately recognizing the location by combining a plurality of identification tests to synthetically judge the location even in a case where some failure has occurred in the terminal or in the network.

### Means to Solve the Problems

The first invention for solving the above-mentioned problem, which is a terminal, is characterized in including:

a recognizing unit for recognizing a connection environment of a network to which its own terminal is in connection;

a setting unit for, responding to a recognition result by the recognizing unit, setting a condition of a filtering; and

a filter for, based upon the condition of the filtering, executing the filtering of transmission/reception data.

The second invention for solving the above-mentioned problem is characterized in, in the above-mentioned first invention, including a displaying controller for displaying the recognition result by the recognizing unit on a displaying screen.

The third invention for solving the above-mentioned problem is characterized in, in the above-mentioned second invention, including an inputting unit for inputting an instruction command that corresponds to the recognition result displayed by the displaying controller.

The fourth invention for solving the above-mentioned problem is characterized in that, in the above-mentioned third invention, the setting unit is configured to set the condition of the filtering based upon the instruction command.

The fifth invention for solving the above-mentioned problem is characterized in that, in the above-mentioned fourth invention, the recognizing unit is configured to compare an IP address allotted to its own terminal with a specification value, and to recognize the connection environment based upon this comparison result.

The sixth invention for solving the above-mentioned problem is characterized in that, in one of the above-mentioned first to fifth inventions, the recognizing unit is configured to perform a test for a continuity with a certain specific server, and to recognize the connection environment based upon a result of this continuity test.

The seventh invention for solving the above-mentioned problem is characterized in that, in one of the above-mentioned first to sixth inventions, the recognizing unit is configured to compare an MAC address of a terminal connected to a network identical to the network to which its own terminal is in connection with a specification value, and to recognize the connection environment based upon this comparison result.

The eighth invention for solving the above-mentioned problem is characterized in that, in one of the above-mentioned first to seventh inventions, the setting unit is configured to set the filtering condition by setting an MAC address, an IP address, or a TCP port number of transmission/reception data that should be filtered.

The ninth invention for solving the above-mentioned problem, which is a method of setting a security, is characterized in including:

a recognizing step of recognizing a connection environment of a network to which its own terminal is in connection;

a setting step of, responding to the recognition result, setting a condition of a filtering; and

a filtering step of, based upon the condition of the filtering, executing the filtering of transmission/reception data.

The tenth invention for solving the above-mentioned problem is characterized in, in the above-mentioned ninth invention, including a displaying step of displaying the recognition result in the recognizing step on a displaying screen.

The eleventh invention for solving the above-mentioned problem is characterized in, in the above-mentioned tenth invention, including an inputting step of inputting an instruction command that corresponds to the recognition result displayed on the displaying screen.

The twelfth invention for solving the above-mentioned problem is characterized in that, in the above-mentioned eleventh invention, the setting step is a step of setting the condition of the filtering based upon the instruction command.

The thirteenth invention for solving the above-mentioned problem is characterized in that, in one of the above-mentioned ninth to twelfth inventions, the recognizing step includes the steps of

comparing an IP address allotted to its own terminal with a specification value; and

recognizing the connection environment based upon the comparison result.

The fourteenth invention for solving the above-mentioned problem is characterized in that, in one of the above-mentioned ninth to thirteenth inventions, the recognizing step includes the steps of:

performing a test for a continuity with a certain specific server; and

recognizing the connection environment based upon a result of the continuity test.

The fifteenth invention for solving the above-mentioned problem is characterized in that, in one of the above-mentioned ninth to fourteenth inventions, the recognizing step includes the steps of:

comparing an MAC address of a terminal connected to a network identical to the network to which its own terminal is in connection with a specification value; and

recognizing the connection environment based upon the comparison result.

The sixteenth invention for solving the above-mentioned problem is characterized in that, in one of the above-mentioned ninth to fifteenth inventions, the setting step is a step of setting the filtering condition by setting an MAC address, an IP address, or a TCP port number of transmission/reception data that should be filtered.

The seventeenth invention for solving the above-mentioned problem, which is a program of a terminal, is characterized in that the program causes the terminal to function as:

a recognizing unit for recognizing a connection environment of a network to which its own terminal is in connection;

a setting unit for, responding to a recognition result by the recognizing unit, setting a condition of a filtering; and

a filter for, based upon the condition of the filtering, executing the filtering of transmission/reception data.

The eighteenth invention for solving the above-mentioned problem is characterized in that, in the above-mentioned seventeenth invention, the program causes the terminal to function as a displaying controller for displaying the recognition result by the recognizing unit on a displaying screen.

The nineteenth invention for solving the above-mentioned problem is characterized in that, in the above-mentioned eighteenth invention, the program causes the terminal to function as an inputting unit for inputting an instruction command that corresponds to the recognition result displayed by the displaying controller.

The twentieth invention for solving the above-mentioned problem is characterized in that, in the above-mentioned nineteenth invention, the program causes the setting unit to function as a unit for setting the condition of the filtering based upon the instruction command.

The twenty-first invention for solving the above-mentioned problem is characterized in that, in one of the above-mentioned seventeenth to twentieth inventions, the program causes the recognizing unit to function as a unit for comparing an IP address allotted to its own terminal with a specification value, and recognizing the connection environment based upon this comparison result.

The twenty-second invention for solving the above-mentioned problem is characterized in that, in one of the above-mentioned seventeenth to twenty-first inventions, the program causes the recognizing unit to function as a unit for performing a test for a continuity with a certain specific server, and recognizing the connection environment based upon a result of this continuity test.

The twenty-third invention for solving the above-mentioned problem is characterized in that, in one of the above-mentioned seventeenth to twenty-second inventions, the program causes the recognizing unit to function as a unit for comparing an MAC address of a terminal connected to a network identical to the network to which its own terminal is in connection with a specification value, and recognizing the connection environment based upon this comparison result.

The twenty-fourth invention for solving the above-mentioned problem is characterized in that, in one of the above-mentioned seventeen to twenty-third inventions, the program causes the setting unit to function as a unit for setting the filtering condition by setting an MAC address, an IP address, or a TCP port number of transmission/reception data that should be filtered.

The present invention performs a test for confirming whether the IP address allotted to the PC coincides with the specification value, notifies its test result to a security setting unit, notifies a setting modification command to a firewall unit based upon its test result, and executes the packet filtering in accordance with its command.

This allows the packet filtering of the firewall to be on/off-controlled based upon whether the IP address allotted to the PC coincides with the value at the time of staying in the safe network.

Controlling only the firewall unit in such a manner makes it possible to prevent the third person from intruding into the PC without being restricted by the method of packing each application. Further, the data as well that is transmitted from the PC toward the network can be filtered with the firewall, thereby making it possible to prevent confidential information of the PC from leaking out to the third person. Further, also in a case where a new application has been installed into the PC, a packet of its application can be filtered with the firewall, which does not demand a time and a burden, and yet is convenient in handling. The first and second objects of the present invention can be accomplished for the above reasons.

In addition hereto, the above-mentioned network recognizing unit performs a test for confirming a continuity with the server mounted into the position that is accessible from any place within the intranet, and notifies its test result to the security setting unit.

The present invention, which assumes such a configuration, on/off-controls the packet filtering of the firewall based upon whether the continuity with the server that is accessible from any place within the intranet can be acquired.

In such a manner, the location is judged based upon whether a confirmation of the continuity with the server that is accessible from any place within the intranet can be acquired, whereby there is no possibility that the location is erroneously recognized even if the PC shifts to the other floor within the company, which is convenient in handling.

Further, it is also possible to authenticate a communication partner by employing authentication information at the time of performing a test for confirming the continuity with the server, and to verifying whether the communication partner with which the continuity was confirmable is really an intended server, thereby enabling the erroneous recognition of the location due to mistaking the communication partner to be prevented, which is convenient in handling.

The first, second, third, and fourth objects of the present invention can be accomplished for the above reasons.

The present invention modifies the process that is performed in the above-mentioned network recognizing unit. The network recognizing unit of the present invention performs not only a test for confirming the continuity with the server, but also a test for confirming the terminal connected to the identical network, or a test for confirming the IP address allotted to its own terminal, and notifies its test result to the security setting unit.

The present invention, which assumes such a configuration, synthesizes a plurality of the test results, thereby to judges the current location.

Performing a plurality of the confirmation tests in such a manner raises a confirmation precision of the location, thereby making it possible to accurately detect the current location even in a case where the failure has occurred in the server or the network of the intranet, which is convenient in handling.

The first, second, third, fourth, and fifth objects of the present invention can be accomplished for the above reasons.

### AN ADVANTAGEOUS EFFECT OF THE INVENTION

The present invention on/off-controls the packet filtering of the firewall based upon whether the IP address allotted to the PC coincides with the value at the time of staying in the safe network.

In such a manner, not the application but the firewall is controlled, thereby making it possible to prevent the third person from intruding into the PC without being restricted by the method of packing each application. Further, data as well that is transmitted from the PC toward the network can be filtered with firewall, thereby making it possible to prevent confidential information of the PC from leaking out to the third person. Further, also in a case where a new application has been installed into the PC, it is possible to executing the filtering of a transmission/reception packet of its application with the firewall without modifying the setting of the PC, which does not demands a time and burden, and yet is convenient in handling. The first and second objects of the present invention can be accomplished for the above reasons.

Further, the present invention on/off-controls the packet filtering of the firewall based upon whether the continuity with the server that is accessible from any place within the intranet can be acquired.

In such a manner, the location is judged based upon whether a confirmation of the continuity with the server that is accessible from any place within the intranet can be acquired, whereby, differently to the conventional case, there is no possibility that the location is erroneously recognized as accompanied by shifting to the other floor, which is convenient in handling. Further, the communication partner is authenticated by employing authentication information at the time of performing a test for confirming the continuity with the server to verify whether the communication partner with which the continuity was confirmable is really an intended server, whereby the erroneous recognition of the location due to mistaking the communication partner is prevented, which is convenient in handling.

The first, second, third, and fourth objects of the present invention can be accomplished for the above reasons.

In addition hereto, in the present invention, the network recognizing unit synthesizes a plurality of the confirmation test results, thereby to judge the current location. Performing a plurality of the confirmation tests in such a manner raises a confirmation precision of the location, thereby making it possible to accurately detect the current location even in a case where the failure has occurred in the server or the network of the intranet, which is convenient in handling.

The first, second, third, fourth, and fifth objects of the present invention can be accomplished for the above reasons.

In addition hereto, the present invention displays a result of the network recognition performed by the network recognition unit on the screen, thereby to notify it to the user, and asks the user to make a judgment as to whether the setting modification of the firewall that corresponds to the recognition result should be made.

Asking the user to make a final judgment as to whether the setting modification of the firewall should be executed in such a manner makes it possible to stop the process of modifying the setting, and to prevent erroneous operation of the firewall also in a case where the network recognizing unit has erroneously recognized the network, which is convenient in handling.

### BRIEF DESCRIPTION OF THE DRAWINGS

FIG. 1 is a block diagram for explaining a first embodiment of the present invention.

FIG. 2 is a block diagram for explaining a configuration of the terminal of the present invention.

FIG. 3 is a flowchart for explaining an operation of the first embodiment of the present invention.

FIG. 4 is a view for explaining a table.

FIG. 5 is a block diagram for explaining second and third embodiments of the present invention.

FIG. 6 is a block diagram for explaining the server of the present invention.

FIG. 7 is a flowchart for explaining an operation of the second embodiment of the present invention.

FIG. 8 is a view for explaining a table.

FIG. 9 is a view for explaining a situation of the network in the third embodiment.

FIG. 10 is a flowchart for explaining an operation of the third embodiment of the present invention.

FIG. 11 is a view for explaining a security mode.

FIG. 12 is a view for explaining tables.

FIG. 13 is a block diagram for explaining a fourth embodiment of the present invention.

FIG. 14 is a view for explaining a display screen.

FIG. 15 is a view illustrating a configuration of the terminal employing the present invention.

### DESCRIPTION OF NUMERALS

41 security setting unit
42 network recognizing unit
43 application
44 data communicating unit
45 firewall unit
46 and 47 tables

### BEST MODE FOR CARRYING OUT THE INVENTION

So as to explain the characteristics of the present invention, hereinafter, the present invention will be specifically described by making a reference to the accompanied drawings. However, if it is appreciated that the embodiments in these drawings and explanations, which signify only a typified embodiment of the present invention, are not be construed as limiting in any way the scope of the present invention, the present invention will be described and explained more definitely and in details by employing the drawings attached below.

The first embodiment for carrying out the present invention will be explained in details by making a reference to the accompanied drawing.

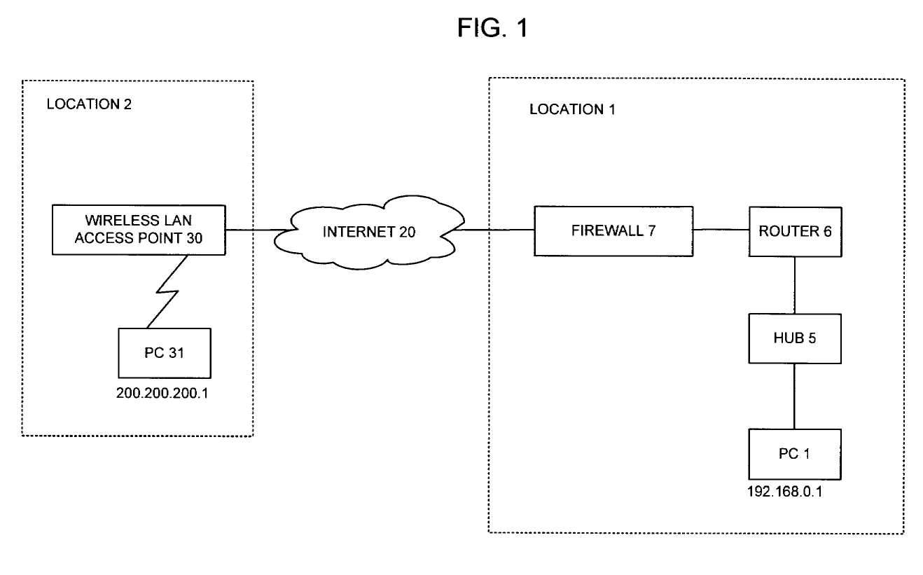

Upon making a reference to FIG. 1, the first embodiment of the present invention includes a location 1 that is isolated from the Internet like the intranet, and is defined as a safe network, and a location 2 that is directly connected to the Internet like a hotspot, and is defined as a risky network.

The location 1 includes a PC 1 such as a personal computer, a router 6 for taking a route control of the packet, a HUB 5 of a wire LAN, and a firewall 7 for executing the filtering of an unauthorized access from the Internet.

The location 2 includes a PC 31 such as a personal computer, and access point 30 of a wireless LAN.

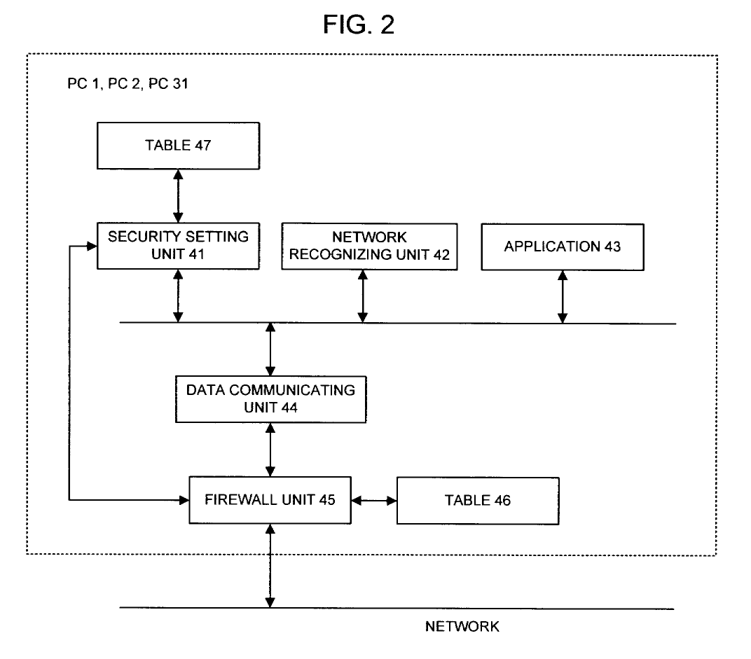

Herein, configurations of the PC 1 and the PC 31 are shown in FIG. 2.

As shown in FIG. 2, each of PC 1 and PC 31 includes a security setting unit 41, a network recognizing unit 42, an application 43, a data communicating unit 44, and a firewall unit 45.

The network recognizing unit 42 checks the IP address allotted to the PC, and performs a test for confirming whether the IP address coincides with a specification value at the time of staying in the safe network. Hereinafter, it is assumed that the specification value at the time of staying in the safe network is pre-set to the PC. The network recognizing unit 42 notifies a result of this confirmation test to the security setting unit 41.

The specification value of the IP address at the time of staying in the safe network is written into a table 46. A user of the computer, a manager thereof, a manager of the network, or the like is thinkable as a creator of this table 46.

Upon receipt the result of the confirmation test from the network recognizing unit 42, the security setting unit 41 notifies a setting modification command to the firewall unit 45 based upon its result. The security setting unit 41 notifies a control command for invalidating a firewall function to the firewall unit 45 in a case where the IP address has coincided with the specification value at the time of staying in the safe network. On the other hand, the security setting unit 41 notifies a control command for validating the firewall function to the firewall unit 45 in a case where the IP address has not coincided with the specification value at the time of staying in the safe network

The application 43, which is software such as Web browser or file sharing software, transmits/receives data to/from other apparatuses connected to the network via the data communicating unit 44.

The data communicating unit 44 makes data communication with other apparatuses connected to the network via the firewall unit 45. For example, upon receipt of a request for data communication from the application 43 to other computers, the data communicating unit 44 generates a packet, and thereafter, sends out its packet to the network. Further, upon receipt of the packet from the network, the data communicating unit 44 checks a destination of its packet, and transfers it to the destination such as the application 43. Herein, as a rule, a TCP/IP function standardizedly installed into the OS (Operating system) is applied for the data communicating unit 44.

Upon receipt of the control command from the security setting unit 41, the firewall unit 45 executes the filtering according to its control command. In a case of having received a control command for validating the firewall function from the security setting unit 41, the firewall unit 45 starts the packet filtering. In this case, the firewall unit 45 checks the packet received from the data communicating unit 44 or the network, and cancels the packet that meets the filtering condition. On the other hand, in a case of having received a control command for invalidating the firewall function from the security setting unit 41, the firewall unit 45 stops the packet filtering. In this case, the firewall unit 45 transfers the packet received from the data communicating unit 44 to the network and the packet received from the network to the data communicating unit 44, respectively, without executing the filtering thereof.

The filtering condition is written into the table 46. A user of the computer, a manager thereof, a manager of the network, or the like is thinkable as a creator of this table 46.

Herein, the firewall unit 45 can be packaged into “an IP firewall hook”, “an intermediate driver”, or the like that is inserted between a data-link layer of a protocol stack and a transport layer.

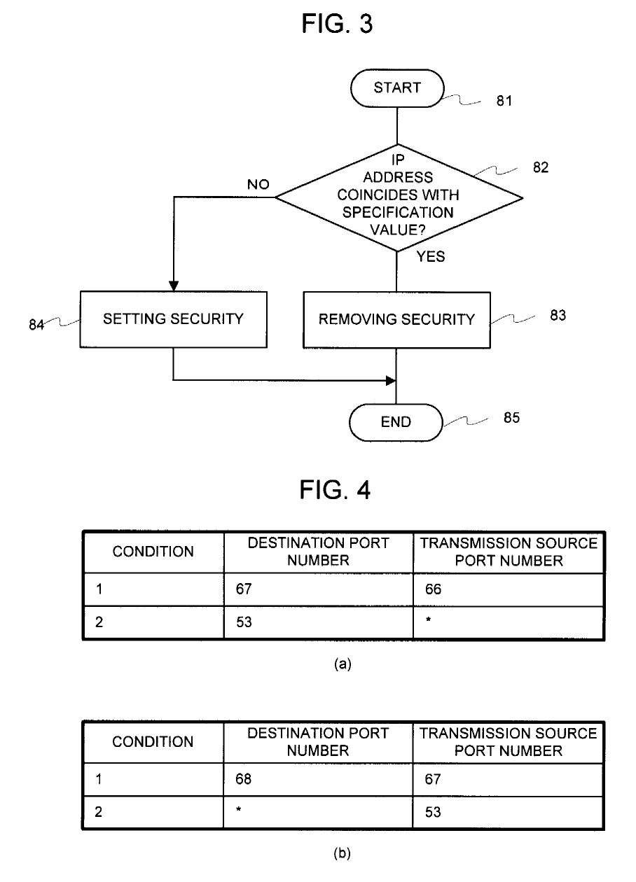

Next, an operation of the first embodiment for carrying out the present invention will be explained in details by making a reference to FIG. 1, FIG. 2, FIG. 3 and FIG. 4.

At first, the network recognizing unit 42 performs a test for confirming whether the IP address allotted to the PC coincides with the value at the time of staying in the safe network with some timing as a trigger (step 82 of FIG. 3).

Any of the followings, or a combination thereof is thinkable as the timing at which the confirmation test is performed.

1. The confirmation test is performed at the time of switching on the power of the PC.

2. It is performed at the time that the network recognizing unit starts the service.

3. It is performed for each constant time interval.

4. It is performed at the time of updating the IP address of the PC.

However, it should be understood that the foregoing timing at which the confirmation test is performed is only an example. Upon attaining an understanding of this explanation, it will be apparent to those skilled in the art that the timing at which the confirmation test is performed assumes the multifarious methods.

The IP address allotted to the PC differs for each location of the PC. For example, with the PC 1 mounted into the location 1 of FIG. 1, a private IP address of 192.168.0.1 is allotted hereto, and with the PC 31 mounted into the location 2, a global IP address of 200.200.200.1 is allotted hereto. In such a manner, the IP address allotted to the PC varies depending upon the location, thereby enabling the current location to be recognized from the IP address.

After the network recognizing unit 42 checks the IP address allotted to the PC, it confirms whether its IP address coincides with a pre-set value. The followings are thinkable as an example of the method of the confirmation that is performed herein.

1. The network recognizing unit 42 confirms whether a subnet address of the IP address coincides with a pre-set value.

2. It confirms whether each of a subnet address and a host address of the IP address coincides with a pre-set value.

Herein, a merit in the case of recognizing the current location only from the subnet address of the IP address, as stated in the above-mentioned 1, will be described below.

In a case where the IP address of the location 1 of FIG. 1 is in operation under a DHCP (Dynamic Host Configuration Protocol), there is the possibility that the IP address to be allotted to the PC 1 is not a fixed value, but fluctuates. For example, the IP address allotted to the PC 1 could be allotted to the other terminal. In this case, not only the IP address of 192.168.0.1 as shown in FIG. 1, but also IP address of 192.168.0.2 is allotted to the PC 1. However, also in this case, the subnet address of the IP address allotted to the PC 1, which remains unchanged, is still 192.168.0.0. For this, judging the location only from the subnet address of the IP address, as stated in the above-mentioned 1, makes it possible to accurately recognize the location even in a case where the network is in operation under the DHCP.

Upon receipt of the notification of the test result from the network recognizing unit 42, the security setting unit 41 performs the process that corresponds to its test result (step 83 and step 84 of FIG. 3). The process of step 83 of FIG. 3 is a process that is performed in the case that the IP address has coincided with the set value, and the security setting unit 41 gives a command for stopping the packet filtering to the firewall unit 45 for a purpose of invalidating the firewall function (step 83 of FIG. 3). On the other hand, in a case where it has been judged that the IP address does not coincide with the set value, the security setting unit 41 gives a command for starting the packet filtering to the firewall unit 45 for a purpose of validating the firewall function (step 84 of FIG. 3).

The firewall unit 45 modifies its operation responding to the control command from the security setting unit 41. In the step 83 of FIG. 3, in a case of having received a command for stopping, the firewall unit 45 stops the process of filtering the packet. In this case, the packet arriving from the network is transferred to the data communicating unit 44 without being filtered, and the packet as well arriving from the data communicating unit 44 is transferred to the network without being filtered.

On the other hand, in the step 84 of FIG. 3, in a case of having received a command for starting, the firewall unit 45 starts the process of filtering the packet. In this case, the firewall unit 45 checks data of the packet arriving from the network or the data communicating unit 44, and cancels the packet that meets the filtering condition. Herein, as a parameter for checking, an MAC header, an IP header, a TCP header of the packet, or the like can be listed. The filtering condition, which has been filed into the table 46 of FIG. 2, can be read/written from the firewall unit 45.

In FIG. 4, an example of the table 46 is shown. FIG. 4(a) shows the filtering condition for the packet having arrived from the data communicating unit 44, and it is judged whether to cancel the packet based upon the destination port number and the transmission source port number. For example, the packet of which the port number does not coincided with the port number shown in FIG. 4(a) is cancelled by the firewall unit 45, and the packet of which the port number coincides with the port number shown in FIG. 4(a) is transferred to the network. Herein, the port number of the condition 1 of FIG. 4(a) is one that corresponds to a DHCP, and the port number of the condition 2 is one that corresponds to a DNS.

On the other hand, FIG. 4(b) shows the filtering condition for the packet having arrived from the network, and no difference of the condition between FIG. 4(a) and FIG. 4(b) exists only that each of the transmission source port number and the destination port number is replaced with the other, so its explanation is omitted.

However, it should be understood that the filtering condition of FIG. 4 is only an example. Upon attaining an understanding of this explanation, it is apparent to those skilled in the art that the filtering conditions of FIG. 4 assume multifarious forms.

Next, a first example of the present invention will be explained by making a reference to the accompanied drawings. Such an example corresponds to the first embodiment of the present invention.

It is assumed that each of the location 1 and the location 2 is a network that is in operation under the DHCP. Herein, it is assumed that the location 1 is a network of which the subnet mask is 255.255.255.0, and of which the network address is 192.168.0.0, and the location 2 is a network of which the subnet mask is 255.255.255.0, and of which the network address is 192.168.1.0.

At first, an operation in the case of having connected the PC 1 to the location 1 is exemplified for explanation. In a case of having connected the PC 1 to the location 1, the address of which the IP address is 192.168.0.1, and of which the subnet mask is 255.255.255.0 is automatically allotted from the router 6, being a DHCP server.

It is assumed that in the PC 1, the network recognizing unit 42 periodically monitors the address allotted to its own terminal for every 10 seconds.

Upon confirming that the IP address has been allotted, the network recognizing unit 42 checks whether its IP address coincides with the specification value pre-set to the table 47. Herein, it is assumed the network address of 192.168.0.0 has been registered into the table 47.

The network address of the address allotted to its own terminal from the router 6 has coincided with the network address registered into this table 47, whereby the network recognizing unit 42 judges that the current location is safe.

When the network recognizing unit 42 judges that the network of a connectee is safe, the security setting unit 41 sends a command to the firewall unit 45 for a purpose of stopping the filtering of the packet.

Upon receipt of the command for stopping the filtering of the packet from the security setting unit 41, the firewall unit 45 modifies its operation so that all packets passes through without stopping. The operation above is an operation in the case of having connected the PC 1 to the location 1.

Next, an example of having connected the PC 1 to the location 2 is exemplified for explanation.

In the case of having connected the PC 1 to the location 2, the address of which the IP address is 192.168.1.1, and of which the subnet mask is 255.255.255.0 is automatically allotted from the wireless LAN access point 30, being a DHCP server hereto.

Upon confirming that the IP address has been allotted, as described above, the PC 1 checks whether its IP address coincides with the specification value pre-set to the table 47. Herein, it is assumed the network address of 192.168.0.0 is registered into the table 47.

The network address of the address allotted to its own terminal from the wireless LAN access point 30 does not coincide with the network address registered into this table 47, whereby the network recognizing unit 42 judges that the current location is risky.

When the network recognizing unit 42 judges that the network of a connectee is risky, the security setting unit 41 sends a command to the firewall unit 45 for a purpose of starting the filtering of the packet.

Upon receipt of the command for starting the filtering of the packet from the security setting unit 41, the firewall unit 45 starts the process of filtering the packet based upon the table 46 into which the filtering conditions have been registered. Herein, it is assumed that information of FIG. 4(a) and FIG. 4(b) has been registered into the table 46. FIG. 4(a) shows the filtering condition for the packet having arrived at the firewall unit 45 from the data communicating unit 44, and it is judged whether the packet is cancelled based upon the destination port number and the transmission source port number. For example, the packet of which the port number does not coincided with the port number shown in FIG. 4(a) is cancelled by the firewall unit 45, and the packet of which the port number coincides with the port number shown in FIG. 4(a) is transferred to the network. Herein, the port number of the condition 1 of FIG. 4(a) is one that corresponds to a DHCP service, and the port number of the condition 2 is one that corresponds to a DNS service.

A specific operation of this firewall unit 45 will be described below.

For example, in a case where the application 43 is Web browser, the application 43 sends out the packet having the destination port number of no. 80.

Upon receipt of this packet, the firewall unit 45 confirms whether the packet meets the filtering condition of the table 46.

The packet having the destination port number of no. 80 has not been registered into the table 46, whereby this packet transmitted from the application 43 is cancelled. The operation above is an operation in the case of having connected the PC 1 to the location 2.

Next, an effect of the first embodiment for carrying out the present invention will be explained.

In the first embodiment of the present invention, the packet filtering of the firewall is on/off-controlled based upon whether the IP address allotted to the PC coincides with the value at the time of staying in the safe network.

Controlling not the application but the firewall in such a manner makes it possible to prevent the third person from intruding into the PC without being restricted by the method of packing each application. Further, the filtering of the data as well that is transmitted from the PC toward the network can be executed with the firewall, thereby making it possible to prevent confidential information of the PC from leaking out to the third person. Further, also in a case where a new application has been installed into the PC, it is possible to execute the filtering of a transmission/reception packet of its application without modifying the setting of the PC, which does not demand a time and burden, and yet is convenient in handling. The first and the second objects of the present invention can be accomplished for the above reasons.

Continuously, a second embodiment of the present invention will be explained.

In the first embodiment of the present invention, the location was recognized from the IP address allotted to the PC. However, in a case of changing the subnet of the IP address of the intranet floor by floor, the IP address allotted to the PC differs floor by floor. In such a case, unless the IP address that could be allotted to the PC is pre-set, resultantly, it is judged that the PC stays in a risky network depending upon the floor even in a case of staying in the location 1, which is inconvenient in handling.

The second embodiment of the present invention is for solving the above-mentioned problems.

Next, the second embodiment of the present invention will be explained in details by making a reference to the accompanied drawings.

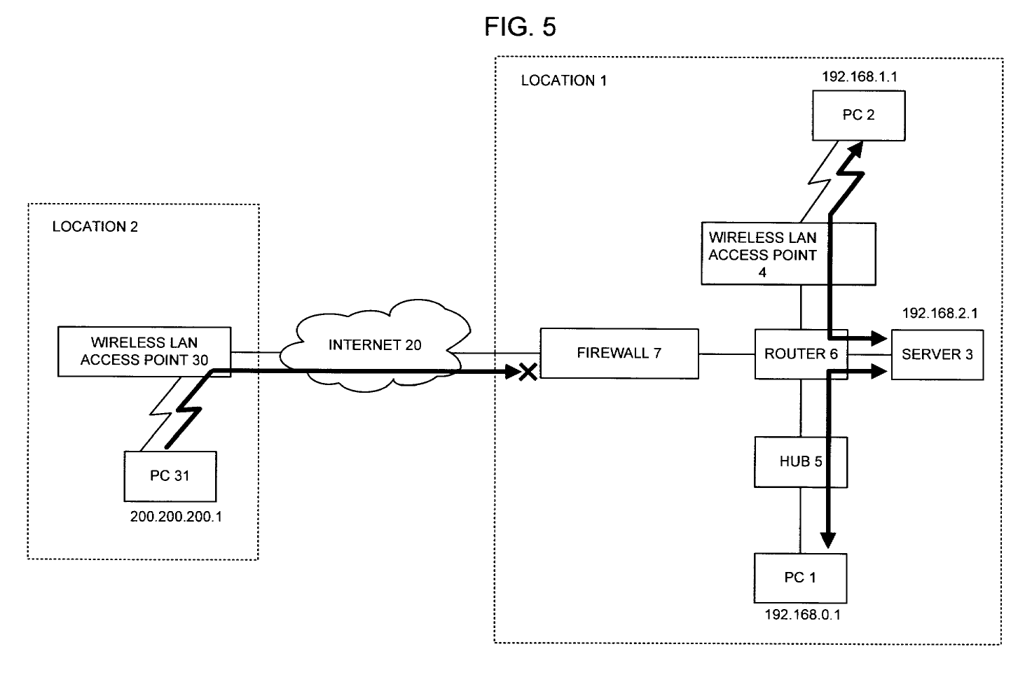

Upon making a reference to FIG. 5, the second embodiment of the present invention includes a location 1 that is isolated from the Internet like the intranet, and is defined as a safe network, and a location 2 that is directly connected to the Internet like a hotspot, and defined as a risky network.

The location 1 includes a PC 1 such as a personal computer, a PC 2 such as a personal computer, a server 3, a router 6 for taking a route control of the packet, an access point 4 of a wireless LAN, a HUB 5 of a wire LAN, and a firewall 7 for executing the filtering of an unauthorized access from the Internet.

The location 2 includes a PC 31 such as a personal computer, and an access point 30 of a wireless LAN.

Herein, configurations of the PC 1, the PC 2, and the PC 31 are shown in FIG. 2.

As shown in FIG. 2, each of the PC 1, the PC 2, and the PC 31 includes a security setting unit 41, a network recognizing unit 42, an application 43, a data communicating unit 44, and a firewall unit 45.

The network recognizing unit 42 performs a test for confirming whether a continuity with the server 3 within the location 1 is acquired via the data communicating unit 44 and the firewall unit 45. The network recognizing unit 42 notifies a result of this confirmation test to the security setting unit 41.

Information for acquiring a confirmation of the continuity with the server 3 is written into a table 47. As information to be written into the table 47, for example, an IP address, a MAC address, a host name of the server 3, or the like is thinkable. A user of the computer, a manager thereof, a manager of the network, or the like is thinkable as a creator of this table 47.

Upon receipt the result of the continuity test from the network recognizing unit 42, the security setting unit 41 notifies a command for modifying the setting to the firewall unit 45 based upon its result. The security setting unit 41 notifies a control command for invalidating the firewall function to the firewall unit 45 in a case where the continuity with the server has been acquired. On the other hand, the security setting unit 41 notifies a control command for validating the firewall function to the firewall unit 45 in a case where the continuity with the server was not acquired.

The application 43, which is software such as Web browser and file sharing software, transmits/receives data to/from other apparatuses connected to the network via the data communicating unit 44.

The data communicating unit 44 makes data communication with other apparatuses connected to the network via the firewall unit 45.

For example, upon receipt of a request for connecting to the server 3 from the network recognizing unit 42, the data communicating unit 44 generates a packet of which the destination is the server 3, and thereafter, sends out its packet to the network. Further, upon receipt of the packet from the network, the data communicating unit 44 checks a destination of its packet, and transfers it to the destination such as the application 43.

Herein, as a rule, a TCP/IP function standardizedly installed into the OS (Operating system) is applied for the data communicating unit 44.

Upon receipt of the control command from the security setting unit 41, the firewall unit 45 executes the filtering according to its control command. In a case of having received a control command for validating the firewall function from the security setting unit 41, the firewall unit 45 starts the packet filtering. In this case, the firewall unit 45 checks the packet received from the data communicating unit 44 or the network, and cancels the packet that meets the filtering condition. On the other hand, in a case of having received a control command for invalidating the firewall function from the security setting unit 41, the firewall unit 45 stops the packet filtering. In this case, the firewall unit 45 transfers the packet received from the data communicating unit 44 to the network, and the packet received from the network to the data communicating unit 44, respectively, without executing the filtering thereof.

The filtering condition is written into the table 46. A user of the computer, a manager thereof, a manager of the network, or the like is thinkable as a creator of this table 46.

Herein, the firewall unit 45 can be packaged into “an IP firewall hook”, “an intermediate driver”, or the like that is inserted between a data-link layer and a transport layer of a protocol stack.

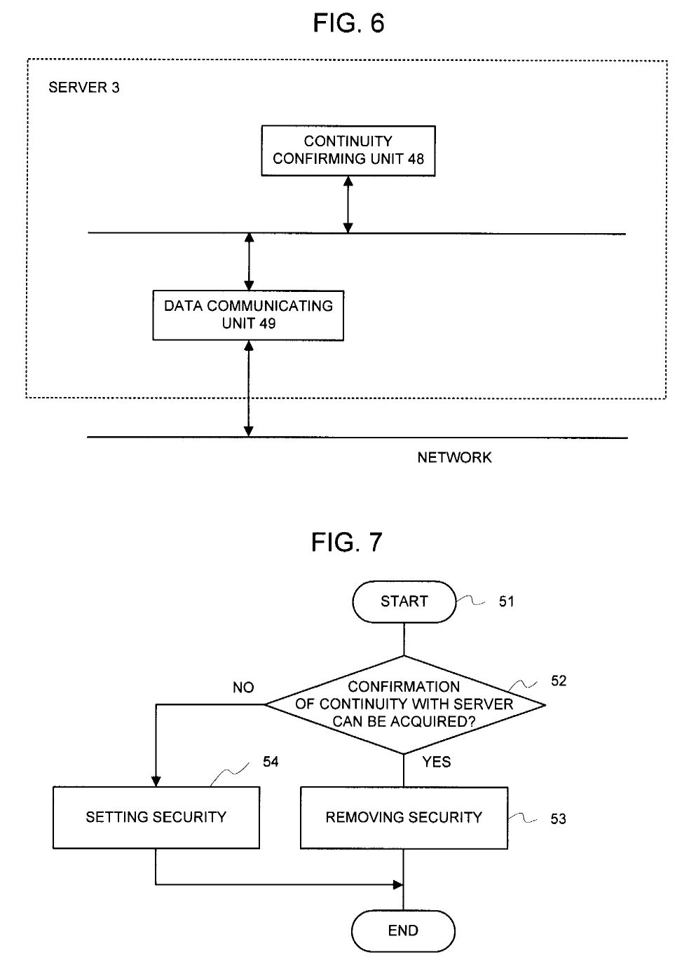

Next, a configuration of the server 3 is shown in FIG. 6.

As shown in FIG. 6, the server 3 includes a continuity confirming unit 48 and a data communicating unit 49.

The continuity confirming unit 48 receives an access for a continuity confirmation test from the network recognizing unit 42 shown in FIG. 2 via the data communicating unit 49, and makes communication necessary for the continuity confirmation with the network recognizing unit 42.

The data communicating unit 49 makes data communication with other apparatuses connected to the network.

For example, upon receipt of a packet from the network, the data communicating unit 49 checks a destination of its packet, and transfers it to the continuity confirming unit 48 etc. Further, upon receipt of a communication request addressed to the network recognizing unit 42 from the continuity confirming unit 48, the data communicating unit 49 generates a packet, and thereafter, sends out its packet to the network.

Herein, as a rule, a TCP/IP function standardizedly installed into the OS (Operating system) is applied for the data communicating unit 49.

Next, an operation of the second embodiment of the present invention will be explained in detail by making a reference to FIG. 7.

At first, the network recognizing unit 42 performs a test for confirming whether the continuity with server 3 can be acquired with some timing as a trigger (step 52 of FIG. 7).

Any of the followings, or a combination thereof is thinkable as the timing at which the confirmation test is performed.

1. The confirmation test is performed at the time of switching on the power of the PC.

2. It is performed at the time that the network recognizing unit starts the service.

3. It is performed for each constant time interval.

4. It is performed at the time of updating the IP address of the PC.

However, it should be understood that the foregoing timing at which the confirmation test is performed is only an example. Upon attaining an understanding of this explanation, it is apparent to those skilled in the art that the timings at which the continuity confirmation test assume multifarious methods.

Further, any of the followings, or a combination thereof is thinkable as the method of confirming the continuity with the server 3.

1. The method of transmitting an ICMP echo request toward the server 3 from the network recognizing unit 42, and confirming whether an ICMP echo reply is returned from the server 3. Employing this method makes it possible to confirm the continuity so far as a Layer-3 level in a so-called TCP/IP protocol.

2. The method of transmitting an ARP (Address Resolution Protocol) request to the IP of the server 3 from the network recognizing unit 42, and confirming whether an ARP reply is returned from the server 3. Employing this method makes it possible to confirm the continuity so far as a Layer-2 level in a so-called TCP/IP protocol.

3. The method of transmitting a TCP connection request (SYN) addressed to a specific port number to the server 3 from the network recognizing unit 42, and confirming whether a TCP connection reply (SYN/ACK) is returned from the server 3. Employing this method makes it possible to confirm the continuity so far as a Layer-7 level in a so-called TCP/IP protocol.

4. The method of confirming the continuity with the server 3 by employing a proprietary unique communication technique. For example, the method of, after establishing a TCP connection to a communication partner, exchanging an ID, a password, a solid number peculiar to the terminal, or the like therewith over its TCP connection, and confirming whether the communication partner is a really the server 3.

However, it should be understood that the foregoing method of confirming the continuity is only an example. Upon attaining an understanding of this explanation, it is apparent to those skilled in the art that the method of confirming the continuity assumes the multifarious aspects.

In the following explanation of the operation, an example in the case of employing the above-mention third method of confirming the continuity will be explained. Specifically, the network recognizing unit 42 transmits a TCP connection request (SYN), which has an IP address of the sever 3 as a destination IP address, and 65535 as a destination port number, respectively, to the server 3, and confirms the continuity based upon whether a TCP connection reply (SYM/ACK) is returned from the server 3.

Herein, the reason why the destination port number is assumed to be 65535 is that an erroneous judgment on the location can be prevented from being made even in a case where the server having an IP address identical to that of the server 3 of the intranet is operating in the outdoor network because no standard application using this port number exists.

The network recognizing unit 42 issues to the data communicating unit 44 a request for the TCP connection to the server 3 for a purpose of confirming the above-mentioned continuity with the server 3.

Upon receipt of the request from the network recognizing unit 42, the data communicating unit 44 affixes a TCP/IP header hereto, thereby to generate a request packet for the TCP connection, and transfers it to the firewall unit 45.

Upon receipt of the request packet for the TCP connection from the data communicating unit 44, the firewall unit 45 transfers it to the network because the pre-setting has been made to this packet so that it passes through without stopping.

This TCP connection request, which is to go toward the server 3 via the network, does not arrive at the server 3 depending upon the location of the PC. For example, the TCP connection request arrives at the server 3 in safety because the PC 1 or the PC 2 mounted into the location 1 of FIG. 5 is in connection to a network identical to that of the server 3.

On the other hand, with the PC 31 mounted into the location 2 of FIG. 5, the firewall 7 is mounted between it and the server 3, and thus, the network is divided. For this, the continuity confirmation cannot be acquired even though the TCP connection request is transmitted from the PC 31 toward the server 3 because the request is filtered with firewall 7.

In the following explanation, an operation will be explained with the case that the TCP connection request has been transmitted from the PC 1 of FIG. 5 toward the server 3 exemplified.

In this case, the TCP connection request transmitted from the PC 1 arrives at the server 3 after passing through the HUB 5 and the router 6.

Upon receipt of the TCP connection request transmitted from the PC 1, the data communicating unit 49 of the server 3 checks a transmission source of its packet, and transmits a TCP connection reply (SYN/ACK) to the PC 1, being a transmission source.

This TCP connection reply arrives at the PC 1 after passing through the router 6 and the HUB 5.

Upon receipt of the reply packet for the TCP connection from the network, the firewall unit 45 of the PC 1 transfers it to the data communicating unit 44 because the pre-setting has been made to this packet so that it passes through without stopping.

Upon receipt of the reply packet for the TCP connection from the firewall unit 45, the data communicating unit 44 generates a reply packet (Ack) of the TCP connection for a purpose of completing a three-way handshake of the TCP connection, and transfers it to the firewall unit 45. Further, the data communicating unit 44 notifies the network recognizing unit 42 the effect that the confirmation of the Layer-7 level continuity with the server 3 was acquired.

Upon receipt of the continuity confirmation result from the data communicating unit 44, the network recognizing unit 42 notifies its result to the security setting unit 41.

Upon receipt of the notification of the test result, the security setting unit 41 performs the process that corresponds to its test result (step 53 and step 54 of FIG. 7). The process of step 53 of FIG. 7 is a process that is performed in the case where the continuity is successful, and the security setting unit 41 gives a command for stopping the packet filtering to the firewall unit 45 for a purpose of invalidating the firewall function (step 53 of FIG. 7). On the other hand, in a case where it has been judged that the continuity is unsuccessful, the security setting unit 41 gives a command for starting the packet filtering to the firewall unit 45 for a purpose of validating the firewall function (step 54 of FIG. 7).

The firewall unit 45 modifies its operation responding to a control command from the security setting unit 41. In the step 53 of FIG. 7, in a case of having received a command for stopping, the firewall unit 45 stops the process of filtering the packet. In this case, the packet arriving from the network is transferred to the data communicating unit 44 without being filtered, and the packet as well arriving from the data communicating unit 44 is transferred to the network without being filtered.

On the other hand, in the step 54 of FIG. 7, in a case of having received a command for starting, the firewall unit 45 starts the process of filtering the data of the packet. In this case, the firewall unit 45 checks the data of the packet arriving from the network or the data communicating unit 44, and cancels the packet that meets the filtering condition. Herein, as a parameter for checking, the MAC header, the IP header, the TCP header of the packet, or the like can be listed. The filtering condition, which has been filed into the table 46 of FIG. 2, can be read/written from the firewall unit 45.

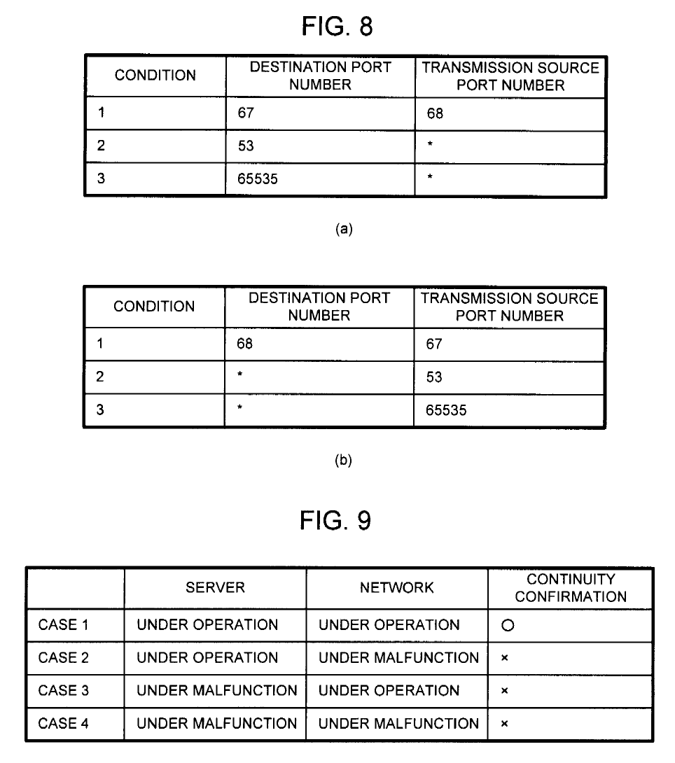

In FIG. 8, an example of the table 46 is shown. FIG. 8(a) shows the filtering condition for the packet having arrived from the data communicating unit 44, and it is judged whether the packet is cancelled based upon the destination port number and the transmission source port number. For example, the packet of which the port number does not coincided with the port number shown in FIG. 8(a) is cancelled by the firewall unit 45, and the packet of which the port number coincides with the port number shown in FIG. 8(a) is transferred to the network. Herein, the port number of the condition 1 of FIG. 8(a) is one that corresponds to a DHCP, the port number of the condition 2 is one that corresponds to a DNS, and the port number of the condition 3 is one that corresponds to a test for confirming the continuity with the server 3.

On the other hand, FIG. 8(b) shows the filtering condition for the packet having arrived from the network, and no difference of the filtering condition between FIG. 8(a) and FIG. 8(b) exists only that each of the transmission source port number and the destination port number is replaced with each other, so its explanation is omitted.

However, it should be understood that the filtering condition of FIG. 8 is only an example. Upon attaining an understanding of this explanation, it is apparent to those skilled in the art that the filtering conditions of FIG. 8 assume the multifarious forms.

Next, a second example of the present invention will be explained by making a reference to the accompanied drawings. Such an example corresponds to the second embodiment of the present invention.

At first, an operation in the case of having connected the PC 1 to the location 1 is exemplified for explanation. Additionally, in the following explanation of the operation, the method of transmitting an ICMP echo request having the IP address of the server 3 as a destination to the server 3 from the network recognizing unit 42, and confirming the continuity based upon whether an ICMP echo reply is returned from the server 3 is employed as a method of confirming the continuity. Further, in the PC 1, it is assumed that the network recognizing unit 42 transmits the ICMP echo request toward the server 3 every ten seconds. Herein, the IP address of the server 3 may be designated as a destination of the ICMP echo request, and the host name of the server 3 may be designated.

The network recognizing unit 42 issues to the data communicating unit 44 a request for the ICMP echo to the server 3 for a purpose of performing the above-mentioned test of the continuity with the server 3.

Upon receipt of the ICMP echo request from the network recognizing unit 42, the data communicating unit 44 affixes a header hereto, thereby to generate an ICMP echo request packet, and transfers it to the firewall unit 45.

Upon receipt of the ICMP echo request packet from the data communicating unit 44, the firewall unit 45 transfers it to the network as it stands because the pre-setting has been made to this packet so that it passes through without stopping.

This ICMP echo request goes toward the server 3 via the HUB 5 and the router 6. The ICMP echo request arrives at the server 3 in safety because the PC 1 mounted into the location 1 of FIG. 5 is in connection to a network identical to that of the server 3.

Upon receipt of the ICMP echo request transmitted from the PC 1, the data communicating unit 49 of the server 3 checks a transmission source of its packet, and transmits an ICMP echo reply to the PC 1, being a transmission source.

This ICMP echo reply arrives at the PC 1 after passing through the router 6 and the HUB 5.

Upon receipt of the ICMP echo reply packet from the network, the firewall unit 45 of the PC 1 transfers it to the data communicating unit 44 as it stands because the pre-setting has been made to this packet so that it passes through without stopping.

Upon receipt of the ICMP echo reply packet from the firewall unit 45, the data communicating unit 44 notifies to the network recognizing unit 42 the effect that the ICMP echo reply has been returned.

Upon confirming that the ICMP echo reply has been returned from the data communicating unit 44, the network recognizing unit 42 notifies its result to the security setting unit 41.

Upon receipt of a notification saying that continuity test is successful, the security setting unit 41 gives a command for stopping the packet filtering to the firewall unit 45 for a purpose of invalidating the firewall function.

The firewall unit 45 stops the process of filtering the packet responding to the control command from the security setting unit 41. In this case, the packet arriving from the network is transferred to the data communicating unit 44 without being filtered, and the packet as well arriving from the data communicating unit 44 is transferred to the network without being filtered.

Next, an operation in the case of having connected the PC 1 to the location 2 is exemplified for explanation.

In the PC 1, it is assumed that the network recognizing unit 42 transmits the ICMP echo request toward the server 3 every ten seconds. Herein, the IP address of the server 3 may be designated as a destination of the ICMP echo request, and the host name of the server 3 may be designated.

The network recognizing unit 42 issues to the data communicating unit 44 a request for the ICMP echo to the server 3 for a purpose of making the above-mentioned confirmation of the continuity with the server 3.

Upon receipt of the ICMP echo request from the network recognizing unit 42, the data communicating unit 44 affixes a header hereto, thereby to generate an ICMP echo request packet, and transfers it to the firewall unit 45.

Upon receipt of the ICMP echo request packet from the data communicating unit 44, the firewall unit 45 transfers it to the network because the pre-setting has been made to this packet so that it passes through without stopping.

The firewall 7 is mounted between the location 2 and the server 3 of FIG. 5, and thus, the network is divided. For this, the continuity confirmation cannot be acquired even though the ICMP echo request is transmitted from the location 2 toward the server 3 of FIG. 5 because the packet is filtered with firewall 7.

Upon confirming that the ICMP echo reply has not been returned from the data communicating unit 44, the network recognizing unit 42 notifies its result to the security setting unit 41.

Upon receipt of this notification saying that the continuity is unsuccessful, the security setting unit 41 gives a command for starting the packet filtering to the firewall unit 45 for a purpose of starting the firewall function.

Upon receipt of the command for starting the filtering of the packet from the security setting unit 41, the firewall unit 45 starts the process of filtering the packet based upon the table 46 into which the filtering conditions have been registered. Herein, it is assumed that information of FIG. 4(a) and FIG. 4(b) is registered into the table 46. FIG. 4(a) shows the filtering condition for the packet having arrived at the firewall unit 45 from the data communicating unit 44, and it is judged whether the packet is cancelled based upon the destination port number and the transmission source port number. For example, the packet of which the port number does not coincided with the port number shown in FIG. 4(a) is cancelled by the firewall unit 45, and the packet of which the port number coincides with the port number shown in FIG. 4(a) is transferred to the network. Herein, the port number of the condition 1 of FIG. 4(a) is one that corresponds to a DHCP service, and the port number of the condition 2 is one that corresponds to a DNS service. Herein, it is assumed that such a rule of executing no filtering for the ICMP packet is registered into the table 46, which is omitted for simplicity. So as to recognize whether the packet is an ICMP packet, it is enough that a protocol type of the IP header is checked.

A specific operation of this firewall unit 45 will be described below.

For example, in a case where the application 43 is Web browser, the application 43 sends out the packet having the destination port number of no. 80.

Upon receipt of this packet, the firewall unit 45 confirms whether the packet meets the filtering condition of the table 46. The packet having the destination port number of no. 80 has not been registered into the table 46, whereby this packet transmitted from the application 43 is cancelled. The operation above is an operation in the case of having connected the PC 1 to the location 2.

Next, an effect of the second embodiment for carrying out the present invention will be explained.

In the second embodiment of the present invention, the packet filtering of the firewall is on/off-controlled based upon whether the continuity with server accessible from any place within the intranet can be acquired.

In such a manner, the location is judged based upon whether the confirmation of the continuity with the server accessible from any place within the intranet can be acquired, whereby, differently to the conventional case, there is no possibility that the location is erroneously recognized as accompanied by shifting to the other floor, which is convenient in handling.

Further, at the time of performing a test for confirming the continuity with the server, by employing authentication information, the communication partner is authenticated to verify whether the communication partner, with which the continuity was confirmable, is really an intended server, whereby the erroneous recognition of the location due to mistaking the communication partner is prevented, which is convenient in handling. The first, second, third, and fourth objects of the present invention can be accomplished for the above reasons.

Continuously, a third embodiment of the present invention will be explained.

In the second embodiment of the present invention, it was judged whether the PC stayed in the location 1, i.e. in the intranet based upon whether a confirmation of the continuity with the server 3 can be acquired. However, as shown in FIG. 9, in some cases, it become impossible to acquire the confirmation of the continuity with the server 3 even in a case of staying in the intranet.

For example, with a case 2 of FIG. 9, it indicates that even though the server 3 works normally, the continuity with the server 3 cannot be acquired because a failure has occurred in the network of the intranet.

Next, with a case 3 of FIG. 9, it indicates that even though the network of the intranet works normally, the continuity with the server 3 cannot be acquired because a failure has occurred in the server 3.

Next, with a case 4 of FIG. 9, it indicates that the continuity with the server 3 cannot be acquired because a failure has occurred not only in the server 3 but also in the network of the intranet.

As mentioned above, the network recognizing unit 42 of FIG. 2 judges that the current location is a risky outdoor network, and thus, validates the firewall function because a confirmation of the continuity with the server 3 cannot be acquired under the conditions of the cases 2, 3, and 4 of FIG. 9 even in a case of staying in the intranet. In this case, the transmission/reception packet results to be filtered by the firewall unit 45, which is inconvenient in handling.

Thereupon, in a third embodiment of the present invention, so as to solve the above-mentioned problem, the process that is performed in the network recognizing unit 42 of FIG. 2 is changed.

The third embodiment of the present invention will be explained in details by making a reference to the accompanied drawings.

The network recognizing unit 42 of the third embodiment of the present invention performs not only a test for confirming the continuity with the server 3 but also a test for confirming the terminal connected to the identical network or a test for confirming the IP address allotted to its own terminal, and notifies its test result to the security setting unit.

Further, information for acquiring a confirmation of the continuity with the server 3, information of the terminals connected to the identical network, information of the IP address that should be allotted to its own terminal, or the like is written into a table 47. A user of the computer, a manager thereof, a manager of the network, or the like is thinkable as a creator of this table 47.

Other components of the third embodiment of the present invention are identical to that of FIG. 2 and FIG. 5, so its explanation is omitted.

An operation of the third embodiment of the present invention will be explained.

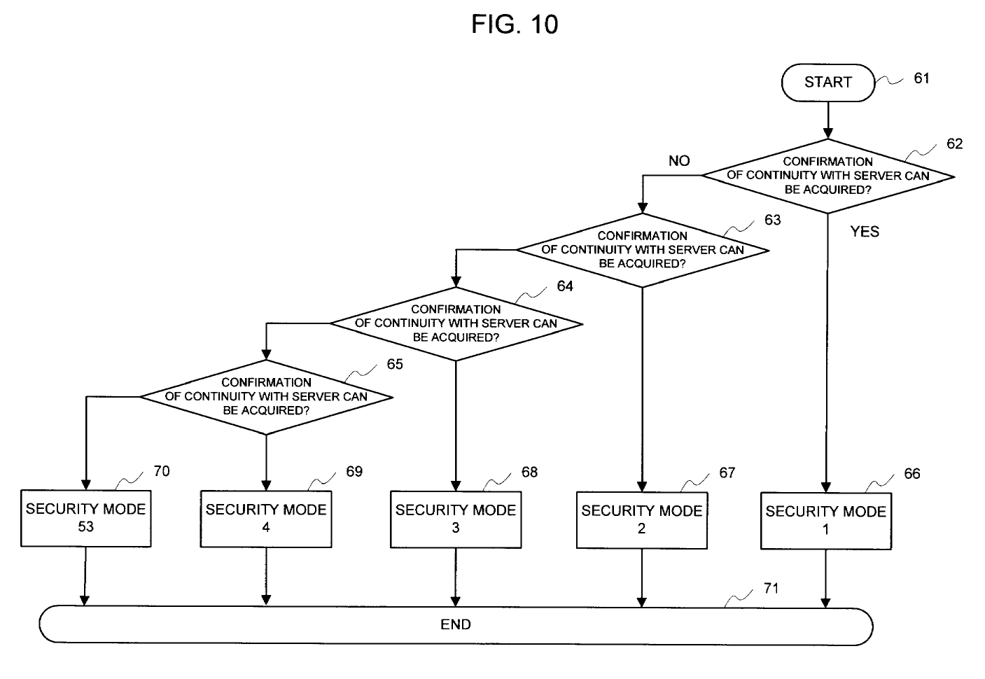

FIG. 10 shows the process that is performed in the network recognizing unit 42.

At first, the network recognizing unit 42 performs a test for confirming whether the continuity with the server 3 can be acquired with some timing as a trigger (step 62 of FIG. 10). The process that is performed in this step 62 is identical to that of the step 52 of FIG. 7, and the timing at which the continuity confirmation test is performed, or the method of confirming it is identical to that of the foregoing embodiments, so its explanation is omitted.

When the network recognizing unit 42 was able to acquire a confirmation of the continuity with the server 3 by the process of this step 62, it notifies information of “an operational mode 1” to the security setting unit 41 (step 66 of FIG. 10). The operational mode that is notified herein relates to a filtering policy that is performed in the firewall unit 45, and the details thereof will be later explained.

On the other hand, in a case where the network recognizing unit 42 was not able to acquire the continuity with the server 3 in the process of this step 62, and yet in a case where the server 3 has equipment redundancy, the network recognizing unit 42 performs a test for confirming whether the continuity with the other server having equipment redundancy can be acquired (step 63 of FIG. 10). The processing content of this step 63 is almost identical to that of the step 62 of FIG. 10 only that the communication partner with which the continuity is confirmed is changed from the server 3 to other server, so its explanation is omitted.

When the network recognizing unit 42 was able to acquire a confirmation of the continuity with the other server by the process of the step 63, it notifies information of “an operational mode 2” to the security setting unit 41 (step 67 of FIG. 10). Further, in this case, it follows that the cause why a confirm of the continuity with the server 3 was not able to be acquired in the step 62 of FIG. 10 is due to occurrence of the failure in the server 3 side, thereby enabling the cause of the failure as well to be specified.

On the other hand, in a case where the network recognizing unit 42 was not able to acquire the continuity with the other server in the process of the step 63, it employ the protocol such as an ARP, thereby to collect information of the other terminals connected to the network (step 64 of FIG. 10). For example, using the ARP enables MAC address information of the other terminals connected to the network to be collected. By checking whether the MAC address collected herein coincides with the MAC address that is collected at the time of being in connection to the intranet, the current location is identified. Additionally, it is guaranteed that the MAC address, which is a value peculiar to each apparatus, is a unique value in the world. For example, each of a default gateway of the intranet and a default gateway of the outdoor network has a different MAC address without fail, thereby making it possible to judge the current location from the MAC address of the default gateway.

When it has been judged that the PC stays in the intranet by the process of the step 64, the network recognizing unit 42 notifies information of “an operational mode 3” to the security setting unit 41 (step 68 of FIG. 10). In this case, it follows that the cause why a confirm of the continuity with the other server was not able to be acquired in the step 63 of FIG. 10 is due to occurrence of the failure in a relay network connecting the PC and the server, thereby enabling the cause of the failure as well to be specified.

On the other hand, in a case where the MAC address collected in the process of the step 64 has not coincided with the MAC address that is collected at the time of being in connection to the intranet, information such as the IP address and the subnet mask allotted to the PC is collected (step 65 of FIG. 10). By checking whether the IP address collected herein coincides with the IP address at the time of being in connection to the intranet, the current location is identified.

When it has been judged that the PC stays in the intranet by the process of the step 65, the network recognizing unit 42 notifies information of “an operational mode 4” to the security setting unit 41 (step 69 of FIG. 10). In this case, it follows that the cause why each of the MAC addresses did not coincide with the other in the step 64 of FIG. 10 is due to occurrence of the failure in the adjacent network connecting the PC and the default gateway etc., thereby enabling the cause of the failure as well to be specified.

On the other hand, in a case where the IP address collected in the process of the step 65 has not coincided with the IP address at the time of being in connection to the intranet, the network recognizing unit 42 judges that the PC stays in the risky network, and notifies information of “an operational mode 5” to the security setting unit 41 (step 70 of FIG. 10).

Above, the operation of the network recognizing unit 42 was explained.

However, it should be understood that the continuity confirmation test that is performed in the network recognizing unit as shown in FIG. 10 is only an example. Upon attaining an understanding of this explanation, it is apparent to those skilled in the art that a combination of the continuity confirmation tests that are performed in the network recognizing unit is performed with the multifarious methods.

Next, the process of the security setting unit 41 will be explained. Upon receipt of the operational mode information from the network recognizing unit 42, the security setting unit 41 send a command to the firewall unit 45 for a purpose of executing the packet filtering responding to its operational mode.

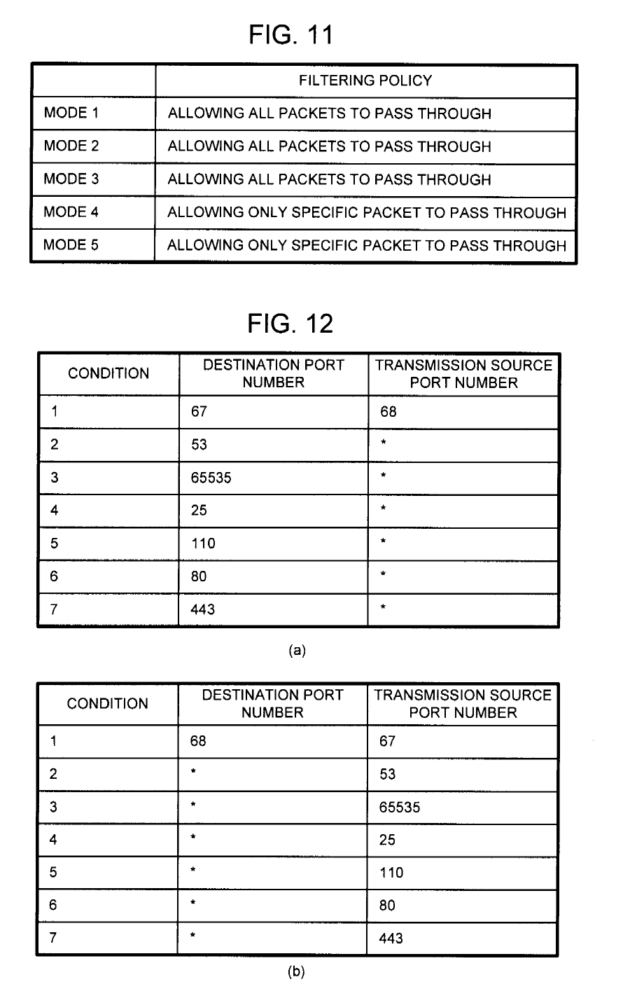

The security setting unit 41 gives a modification command to the firewall unit 45 so that the setting, which corresponds to the operational mode received from the network recognizing unit 41, is attained. An example of the filtering policy of each operational mode is shown in FIG. 11.

Herein, the reason why the filtering policy differs operational mode by operational mode is due to an accuracy of the confirmation test in the network recognizing unit 42. For example, as a rule, the operational mode 1 is issued in a case where a confirmation of the continuity with the server 3 was able to be acquired in the network recognizing unit 42, and the possibility that the PC is in connection to the intranet is very high in a case where the method of confirming the continuity based upon whether the TCP connection of the port number, which does not use a standard application, can be established is employed as a method of confirming the continuity, as described in the first embodiment.

On the other hand, as a rule, the operational mode 4 is issued in a case where the IP address allotted to the PC has coincided with the IP address at the time of staying in the intranet; however this coincidence may be nothing but an accidental coincidence of the IP address at the time of staying in the outdoors and the IP address at the time of staying in the intranet, whereby in this case, the possibility that the PC is in connection to the intranet is low.

In such a manner, a precision as to whether a client is in connection to the intranet differs depending upon the operational mode, and also in this case, a scheme for maintaining the security level of the PC is necessitated. In the second embodiment of the present invention, such a difference of a precision is compensated by the filtering policy.

For example, the precision at the time that the operational mode is the operational mode 1 is sufficiently reliable, whereby all packets, which are not filtered, are allowed to pass through without stopping, whereas the precision at the time that the operational mode is the operational mode 4 is not sufficiently reliable, whereby only a specific packet is allowed to pass through without stopping (FIG. 11). Herein, the so-called specific packet is a packet adapted so that it is not cancelled in the firewall unit 45 for a purpose of enabling the applications such mail (POP and SMTP) and web (HTTP) to be used.

Upon reading off these settings from the table 47, the security setting unit 41 notifies a command for modifying the filtering setting to the firewall unit 45.

The firewall unit 45 modifies its filtering process according to the modification command from the security setting unit 41. Herein, the firewall unit 45 has the filtering condition that corresponds to each operational mode for a purpose of modifying the filtering process responding to the operational mode. No filtering condition particularly exists in the operational modes 1, 2, and 3 because all packets are allowed to pass through without stopping. On the other hand, the filtering condition of the operational mode 5 is one shown in FIG. 8, and its content was already described in the second embodiment of the present invention, so its explanation is omitted.

FIG. 12 shows the filtering condition of the operational mode 4. Herein, the specific packets, of which the destination port number are no. 25 (SMTP), no. 110 (POP), no. 80 (HTTP), and no. 443 (HTTPS), respectively, are set so that they are not canceled in the firewall unit 45 for purpose of enabling the mail and the web to be used. FIG. 12(a) shows the filtering condition for the packet having arrived from the data communicating unit, and FIG. 12(b) shows the filtering condition for the packet having arrived from the network.

Next, a third example of the present invention will be explained by making a reference to the accompanied drawings. Such an example corresponds to the third embodiment of the present invention.

At first, an operation in the case of having connected the PC 1 to the location 1 is exemplified for explanation. Additionally, in the following explanation of the operation, it is assumed that the method of transmitting a ICMP echo request having the IP address of the server as a destination to the server from the network recognizing unit 42, and confirming the continuity based upon whether an ICMP echo reply is returned from the server is employed as a method of confirming the continuity. Further, in the PC 1, it is assumed that the network recognizing unit 42 transmits the ICMP echo request toward the server every ten seconds. Herein, the IP address of the server may be designated as a destination of the ICMP echo request, and the host name of the server may be designated.

The network recognizing unit 42 issues to the data communicating unit 44 a request for the ICMP echo to the server 3 for a purpose of performing the above-mentioned test of the continuity with the server 3.

Upon receipt of the ICMP echo request from the network recognizing unit 42, the data communicating unit 44 affixes a header hereto, thereby to generate an ICMP echo request packet, and transfers it to the firewall unit 45.

Upon receipt of the ICMP echo request packet from the data communicating unit 44, the firewall unit 45 transfers it to the network as it stands because the pre-setting has been made to this packet so that it passes through without stopping.

This ICMP echo request goes toward the server 3 via the HUB 5 and the router 6. The ICMP echo request arrives at the server 3 in safety because the PC 1 mounted into the location 1 of FIG. 5 is in connection to a network identical to that of the server 3.

Upon receipt of the ICMP echo request transmitted from the PC 1, the data communicating unit 49 of the server 3 checks a transmission source of its packet, and transmits an ICMP echo reply to the PC 1, being a transmission source.

This ICMP echo reply arrives at the PC 1 after passing through the router 6 and the HUB 5.

Upon receipt of the ICMP echo reply packet from the network, the firewall unit 45 of the PC 1 transfers it to the data communicating unit 44 as it stands because the pre-setting has been made to this packet so that it passes through without stopping.

Upon receipt of the ICMP echo reply packet from the firewall unit 45, the data communicating unit 44 notifies to the network recognizing unit 42 the effect that the ICMP echo reply has been returned.

Upon confirming that the ICMP echo reply has been returned from the data communicating unit 44, the network recognizing unit 42 notifies information of “an operational mode 1” to the security setting unit 41.

Upon receipt of the information of “the operational mode 1”, the security setting unit 41 gives a command for stopping the packet filtering to the firewall unit 45 for a purpose of allowing all packets to pass through.

The firewall unit 45 stops the process of filtering the packet responding to the control command from the security setting unit 41. In this case, the packet arriving from the network is transferred to the data communicating unit 44 without being filtered, and the packet as well arriving from the data communicating unit 44 is transferred to the network without being filtered.

On the other hand, the network recognizing unit 42 issues to the data communicating unit 44 a request for the ICMP echo to the other server for a purpose of performing the above-mentioned test of the continuity with the other server having equipment redundancy in a case where it was not able to receive the ICMP echo reply packet for a certain period.

Upon receipt of the ICMP echo request from the network recognizing unit 42, the data communicating unit 44 affixes a header hereto, thereby to generate an ICMP echo request packet, and transfers it to the firewall unit 45.

Upon receipt of the ICMP echo request packet from the data communicating unit 44, the firewall unit 45 transfers it to the network as it stands because the pre-setting has been made to this packet so that it passes through without stopping.

This ICMP echo request goes toward the other server having equipment redundancy via the HUB 5 and the router 6. The ICMP echo request arrives at the other server having equipment redundancy in safety because this server is in connection to a network identical to that of the PC 1.

Upon receipt of the ICMP echo request transmitted from the PC 1, the data communicating unit 49 of the server checks a transmission source of its packet, and transmits an ICMP echo reply to the PC 1, being a transmission source.

This ICMP echo reply arrives at the PC 1 after passing through the router 6 and the HUB 5.

Upon receipt of the ICMP echo reply packet from the network, the firewall unit 45 of the PC 1 transfers it to the data communicating unit 44 as it stands because the pre-setting has been made to this packet so that it passes through without stopping.

Upon receipt of the ICMP echo reply packet from the firewall unit 45, the data communicating unit 44 notifies to the network recognizing unit 42 the effect that the ICMP echo reply has been returned.

Upon confirming that the ICMP echo reply has been returned from the data communicating unit 44, the network recognizing unit 42 notifies information of “an operational mode 2” to the security setting unit 41.

Upon receipt of the information of “the operational mode 2”, the security setting unit 41 judges that the cause why a confirmation of the continuity with server 3 was not able to be acquired is not due to a problem with the security, but due to occurrence of some failure in the server 3, and gives a command for stopping the packet filtering to the firewall unit 45 for a purpose of allowing all packets to pass through.

The firewall unit 45 stops the process of filtering the packet responding to the control command from the security setting unit 41. In this case, the packet arriving from the network is transferred to the data communicating unit 44 without being filtered, and the packet as well arriving from the data communicating unit 44 is transferred to the network without being filtered.

On the other hand, in a case where the network recognizing unit 42 was not able to receive the ICMP echo reply packet for a certain period, it inserts an IP address 192.168.1.1 of the PC 2, being another terminal, into an ARP inquiry, and transmits it. The network recognizing unit 42 receives a reply to this ARP inquiry, collects the MAC address of the PC 2, and judges whether that the PC 2 is in connection to the intranet.

When the collected MAC address coincides with an MAC address that is collected at the time of being in connection to the intranet, the network recognizing unit 42 notifies information of “an operational mode 3” to the security setting unit 41.

Upon receipt of the information of “the operational mode 3”, the security setting unit 41 judges that the cause why a confirmation of the continuity with server having equipment redundancy was not able to be acquired is not due to a problem with the security, but due to occurrence of some failure in the relay network, and gives a command for stopping the packet filtering to the firewall unit 45 for a purpose of allowing all packets to pass through.

The firewall unit 45 stops the process of filtering the packet responding to the control command from the security setting unit 41. In this case, the packet arriving from the network is transferred to the data communicating unit 44 without being filtered, and the packet as well arriving from the data communicating unit 44 is transferred to the network without being filtered.

In a case where the collected MAC address has not coincided with an MAC address that is collected at the time of being in connection to the intranet, the network recognizing unit 42 confirms its own IP address.

It is checked whether its own IP address coincides with a specification value pre-set to the table 47. Herein, it is assumed that a network address of 192.168.0.0 is registered into the table 47.

The IP address allotted to its own terminal has coincided with a specification value registered into the table 47, whereby the network recognizing unit 42 judges that the possibility as well that the IP address allotted to its own terminal, which coincides with the IP address at the time of being in connection to the intranet, accidentally coincides with the IP address at the time of staying in the outdoors exists, and notifies information of “an operational mode 4” to the security setting unit 41.

Upon receipt of the information of “the operational mode 4”, the security setting unit 41 gives a command for starting the filtering to the firewall unit 45 for a purpose of allowing a specific packet to pass through.

Upon receipt of the command for starting the filtering from the security setting unit 41, the firewall unit 45 starts the packet filtering based upon the table 46 into which the filtering has been registered. Additionally, an example relating to the filtering is identical to that of the foregoing example, so its explanation is omitted.

Continuously, an operation in the case of having connected the PC 1 to the location 2 is exemplified for explanation. In the case of having connected the PC 2 to the network of the location 2, the address of which the IP address is 192.168.1.1, and of which the subnet mask is 255.255.255.0 is automatically allotted from the wireless LAN access point 30, being a DHCP server, hereto.

In the PC 1, it is assumed that the network recognizing unit 42 transmits the ICMP echo request toward the server 3 every ten seconds. Herein, the IP address of the server 3 may be designated as a destination of the ICMP echo request, and the host name of the server 3 may be designated.

The network recognizing unit 42 issues to the data communicating unit 44 a request for the ICMP echo to the server 3 for a purpose of making the above-mentioned confirmation of the continuity with the server 3.

Upon receipt of the ICMP echo request from the network recognizing unit 42, the data communicating unit 44 affixes a header hereto, thereby to generate an ICMP echo request packet, and transfers it to the firewall unit 45.

Upon receipt of the ICMP echo request packet from the data communicating unit 44, the firewall unit 45 transfers it to the network because the pre-setting has been made to this packet so that it passes through without stopping.

The firewall 7 is mounted between the location 2 and the server 3 of FIG. 5, and thus, the network is divided. For this, even though the ICMP echo request is transmitted from the location 2 toward the server 3 of FIG. 5, the continuity confirmation cannot be acquired because the packet is filtered with firewall 7.

Upon confirming that the ICMP echo reply has not been returned from the data communicating unit 44, the network recognizing unit 42 issues to the data communicating unit 44 a request for the ICMP echo to the other server having equipment redundancy for a purpose of performing the above-mentioned test of the continuity with the other server having equipment redundancy.

Similarly to the case of a confirmation of the continuity with the server 3, the firewall 7 is mounted between the location 2 and the server 3 of FIG. 5, and thus, the network is divided. For this, even though the ICMP echo request is transmitted from the location 2 toward the server of FIG. 5 having equipment redundancy, the continuity confirmation cannot be acquired because the packet is filtered with firewall 7.

Upon receipt of this notification saying that the continuity is unsuccessful, the network recognizing unit 42 inserts an IP address 192.168.1.1 of the PC 2, being another terminal, into an ARP inquiry, and transmits it.

Upon receipt of the ARP inquiry from the network recognizing unit 42, the data communicating unit 44 affixes a header hereto, thereby to generate a packet for the ARP inquiry, and transfers it the firewall unit 45.

Upon receipt of the packet for the ARP inquiry from the data communicating unit 44, the firewall unit 45 transfers it to the network because the pre-setting has been made to this packet so that it passes through without stopping.

The firewall 7 is mounted between the location 2 and the server 3 of FIG. 5, and thus, the network is divided. For this, even though the ARP inquiry is transmitted from the location 2 toward the PC 2 of FIG. 5, the MAC address of the PC 2 cannot be collected because the packet is filtered with firewall 7.

However, the case that the terminal of which the IP address is “192.168.1.1” accidentally exists, and its terminal transmits the MAC address responding to the ARP inquiry is also thinkable because the ARP inquiry is broadcasted. In this case, the network recognizing unit 42 confirms whether the transmitted MAC address is identical to the MAC address that is collected at the time of being in connection to the intranet. The received MAC address is not the MAC address of the PC 2, whereby the network recognizing unit 42 judges that the transmitted MAC address is not identical to the MAC address that is collected at the time of being in connection to the intranet, and confirms its own IP address.

It is checked whether its own IP address coincides with a specification value pre-set to the table 47. Herein, it is assumed that a network address of 192.168.0.0 is registered into the table 47.

The network address of the address allotted to its own terminal from the wireless LAN access point 30 has not coincided with the network address registered into this table 47, whereby the network recognizing unit 42 judges that the current location is risky.

When it is judged in the network recognizing unit 42 that the network of a connectee is risky, the security setting unit 41 notifies information of “an operational mode 5” to the firewall unit 45.

Upon receipt of information of “the operational mode 5”, the security setting unit 41 gives a command for starting the filtering to the firewall unit 45 for a purpose of allowing a specific packet to pass through. Additionally, an example relating to the filtering is identical to that of the foregoing example, so its explanation is omitted.

Next, an effect of the third embodiment for carrying out the present invention will be explained.

In the third embodiment for carrying out the present invention, the network recognizing unit 42 synthesizes a plurality of the confirmation test results, thereby to judge the current location. Performing a plurality of the confirmation tests in such a manner raises a recognition precision of the location, thereby enabling the current location to be accurately detected even in a case where a failure has occurred in the server or the network of the intranet, which is convenient in handling.

The first, second, third, fourth, and fifth objects of the present invention can be accomplished for the above reasons.

Continuously, a fourth embodiment of the present invention will be explained.

In the first, second, and third embodiments of the present invention, the setting of the packet filtering of the firewall unit 45 was automatically controlled based upon the network recognition result by the network recognizing unit 42 of FIG. 2. Performing the process automatically in such a manner allowed a time and burden necessary for the user modifying the security setting manually responding to the place to be omitted, and damage to the security level of the PC due to a human operational error to be prevented.

However, automatically controlling the firewall unit 45 irrespectively of a user's intention causes the firewall unit 45 to operate erroneously in a case where the network recognizing unit 42 has erroneously recognized the network, or the like. For example, even in a case of staying in the intranet, if the network recognizing unit 42 has judged erroneously that the PC stays in the risky outdoor network due to some failure, it follows that the firewall unit 45 performs the filtering of the packet, which causes inconvenience to the user in handling.

Next, the fourth embodiment of the present invention will be explained in details by making a reference to the accompanied drawings.

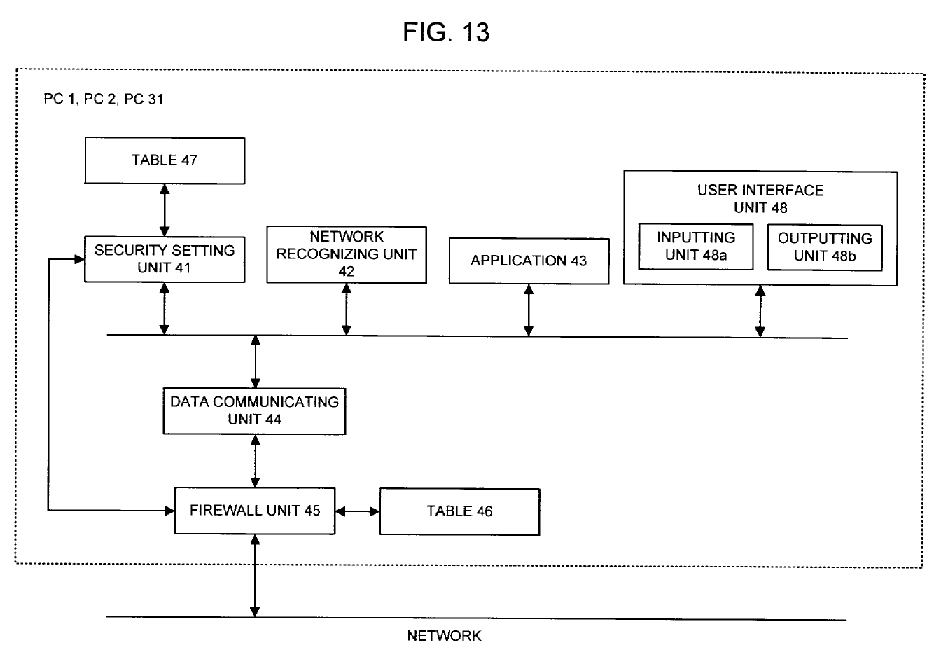

In the fourth embodiment of the present invention, so as to solve the above-mentioned problems, the configuration of the PC is changed as shown in FIG. 13. As shown in FIG. 13, the PC of the fourth embodiment includes a user interface unit 48 in addition to the configuration of FIG. 2. Herein, the user interface unit 48 includes an inputting unit 48a and an outputting unit 48b.

The network recognizing unit 41 performs the test for confirming the network mentioned in the first, second, and third embodiments of the present invention, and notifies this confirmation test result to the outputting unit 48b.

Upon receipt of the network confirmation test result from the network recognizing unit 42, the outputting unit 48b displays the network confirmation test result on a displaying device such as a monitor, thereby to notify it to the user.

The inputting unit 48a receives a command input by the user with a keyboard operation etc. for the network confirmation test result displayed by the outputting unit 48b, and notifies its command to the security setting unit 41.

Upon receipt of the command from the inputting unit 48a, the security setting unit 41 notifies a setting modification command to the firewall unit 45 based upon its command.

Other components are identical to the configuration of FIG. 2, so its explanation is omitted.

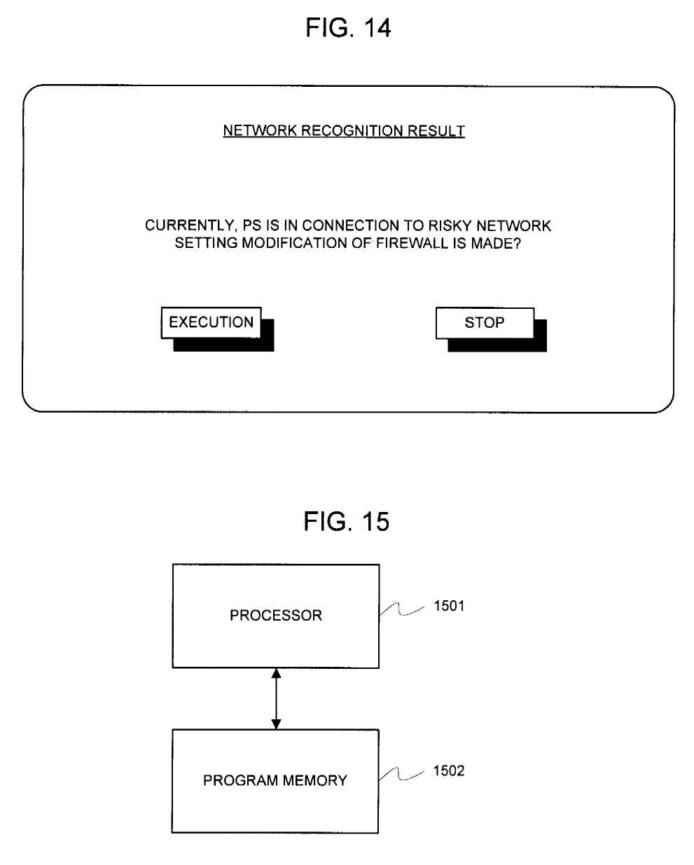

Next, an operation of the fourth embodiment for carrying out the present invention will be explained in details by making a reference to FIG. 13 and FIG. 14.

The network recognizing unit 41 performs a test for recognizing the network to which a connection has been made with some timing as a trigger as described in the first, second, and third embodiments of the present invention. The method of the recognition test as well is one described in the first, second, and third embodiments of the present invention, so its explanation is omitted. The network recognizing unit 41 notifies a recognition result obtained in such a manner to the outputting unit 48b.

Upon receipt of this recognition result from the user interface unit 48, the outputting unit 48b displays its recognition result on a displaying device such as a monitor for a purpose of notifying information of the network to which a connection has been made to the user. FIG. 14 shows an example of a screen 91 that the outputting unit 48b displays. The screen 91 includes not only a function of displaying the recognition result of the network, but also an execution button and a stop button capable of making a decision as to whether to make a modification setting, which corresponds to the recognition result, to the firewall unit 45.

Any of the followings, or a combination thereof is thinkable as a timing at which the outputting unit 48b outputs this screen 91 to the displaying devise such as a monitor.

1. The outputting unit 48b displays the screen 91 on the displaying device at any time, and modifies the display content of the screen 91 at the time of having received the network recognition result from the network recognizing unit 41.

2. The outputting unit 48b displays the screen 91 on the displaying device at the time of having received the network recognition result from the network recognizing unit 41.

3. The outputting unit 48b displays the screen 91 on the displaying device only in a case where it receives the network recognition result from the network recognizing unit 41, and yet the received recognition result differs from the last-time recognition result.

However, it should be understood that each of the foregoing display content of the screen 91, and the timing at which the screen 91 is displayed is only an example. Upon attaining an understanding of this explanation, it is apparent to those skilled in the art that each of the foregoing display content of the screen 91 and the timing at which the screen 91 is displayed assumes the multifarious aspects.

In a case where the user confirms the content of the network recognition result displayed on the screen, judges that the network recognition result displayed on the screen 91 is correct, and desires to make the setting modification of the firewall unit 45 that corresponds to the recognition result, it will push the execution button.

On the other hand, as a result of the user's confirming the content of the network recognition result, in a case where an error exists in the network recognition result, or in a case where the user does not desire to make the setting modification of the firewall unit 45 that corresponds to the recognition result, it will push the stop button.

The inputting unit 48a receives an instruction command from the user through the operation by the above-mention buttons. If the user has pushed the execution button, the inputting unit 48a notifies to the security setting unit 41 the effect that the setting modification of the firewall that corresponds to the network recognition result should be made.

Further, if the user has pushed the stop button, the inputting unit 48a does not make a notification to the security setting unit 41, and a series of the processes is finished.

The operation after the foregoing is identical to that of the first, second, and third embodiments of the present invention, so its explanation is omitted.

Next, an effect of the fourth embodiment for carrying out the present invention will be explained.

In the fourth embodiment for carrying out the present invention, the result of the network recognition performed in the network recognizing unit is displayed on the screen to notify it to the user, thereby asking the user a judgment as to whether the setting modification of the firewall that corresponds to the recognition result should be made.

In such a manner, asking the user a final judgment as to whether the setting of the firewall should be modified makes it possible to stop the process of modifying the setting and to prevent the erroneous operation of the firewall even in a case where the network recognizing unit has erroneously recognized the network, which is convenient in handling.

Additionally, as apparent from the above-mentioned explanation, the foregoing terminal of the present invention also can be configured of hardware, and also can be configured of computer programs.

FIG. 15 is a configuration view of a terminal obtained by implementing the terminal in accordance with the present invention.

The terminal shown in FIG. 15 includes a processor 1501 and a program memory 1502.

The processor that operates under a program filed in the program memory allows a function and an operation similar to that of the foregoing embodiments to be realized.

1. A terminal, characterized in comprising:
a recognizing unit for recognizing a connection environment of a network to which its own terminal is in connection;
a setting unit for, responding to a recognition result by said recognizing unit, setting a condition of a filtering; and
a filter for, based upon said set condition of the filtering, executing the filtering of transmission/reception data.

2. The terminal according to claim 1, characterized in comprising a displaying controller for displaying a recognition result by said recognizing unit on a displaying screen.

3. The terminal according to claim 2, characterized in comprising an inputting unit for inputting an instruction command, said instruction command corresponding to said recognition result displayed by said displaying controller.

4. The terminal according to claim 3, characterized in that said setting unit is configured to set said condition of the filtering based upon said instruction command.

5. The terminal according to claim 1, characterized in that said recognizing unit is configured to compare an IP address allotted to its own terminal with a specification value, and to recognize said connection environment based upon this comparison result.

6. The terminal according to claim 1, characterized in that said recognizing unit is configured to perform a test for a continuity with a certain specific server, and to recognize said connection environment based upon a result of this continuity test.

7. The terminal according to claim 1, characterized in that said recognizing unit is configured to compare an MAC address of a terminal connected to a network identical to the network to which its own terminal is in connection with a specification value, and to recognize said connection environment based upon this comparison result.

8. The terminal according to claim 1, characterized in that said setting unit is configured to set the filtering condition by setting an MAC address, an IP address, or a TCP port number of transmission/reception data which should be filtered.

9. A method of setting a security, characterized in comprising:
a recognizing step of recognizing a connection environment of a network to which its own terminal is in connection;
a setting step of, responding to said recognition result, setting a condition of a filtering; and
a filtering step of, based upon said condition of the filtering, executing the filtering of transmission/reception data.

10. The method of setting a security according to claim 9, characterized in comprising a displaying step of displaying a recognition result in said recognizing step on a displaying screen.

11. The method of setting a security according to claim 10, characterized in comprising an inputting step of inputting an instruction command, said instruction command corresponding to said recognition result displayed on said displaying screen.

12. The method of setting a security according to claim 11, characterized in that said setting step is a step of setting said condition of the filtering based upon said instruction command.

13. The method of setting a security according to claim 9, characterized in that said recognizing step comprises the steps of:
comparing an IP address allotted to its own terminal with a specification value; and
recognizing said connection environment based upon said comparison result.

14. The method of setting a security according to claim 9, characterized in that said recognizing step includes the steps of:
performing a test for a continuity with a certain specific server; and
recognizing said connection environment based upon a result of said continuity test.

15. The method of setting a security according to claim 9, characterized in that said recognizing step comprises the steps of:
comparing an MAC address of a terminal connected to a network identical to the network to which its own terminal is in connection with a specification value; and
recognizing said connection environment based upon said comparison result.

16. The method of setting a security according to claim 9, characterized in that said setting step is a step of setting the filtering condition by setting an MAC address, an IP address, or a TCP port number of transmission/reception data that should be filtered.

17. A program of a terminal, characterized in causing said terminal to function as:
a recognizing unit for recognizing a connection environment of a network to which its own terminal is in connection;
a setting unit for, responding to a recognition result by said recognizing unit, setting a condition of a filtering; and
a filter for, based upon said set condition of the filtering, executing the filtering of transmission/reception data.

18. The program according to claim 17, characterized in causing said terminal to function as a displaying controller for displaying a recognition result by said recognizing unit on a displaying screen.

19. The program according to claim 18, characterized in causing said terminal to function as an inputting unit for inputting an instruction command, said instruction command corresponding to said recognition result displayed by said displaying controller.

20. The program according to claim 19, characterized in causing said setting unit to function as a unit for setting said condition of the filtering based upon said instruction command.

21. The program according to claim 17, characterized in causing said recognizing unit to function as a unit for comparing an IP address allotted to its own terminal with a specification value, and recognizing said connection environment based upon this comparison result.

22. The program according to claim 17, characterized in causing said recognizing unit to function as a unit for performing a test for a continuity with a certain specific server, and recognizing said connection environment based upon a result of this continuity test.

23. The program according to claim 17, characterized in causing said recognizing unit to function as a unit for comparing an MAC address of a terminal connected to a network identical to the network to which its own terminal is in connection with a specification value, and recognizing said connection environment based upon this comparison result.

24. The program according to claim 17, characterized in causing said setting unit to function as a unit for setting the filtering condition by setting an MAC address, an IP address, or a TCP port number of transmission/reception data that should be filtered.
